(19) United States
(12) Patent Application Publication
(10) Pub. No.: US 2022/0114509 A1
(43) Pub. Date: Apr. 14, 2022

(54) DECENTRALIZED DOMAIN-ORIENTED DATA ARCHITECTURE

(71) Applicant: JPMorgan Chase Bank, N.A., New York, NY (US)

(72) Inventors: Ralph Joseph PINHEIRO, Paoli, PA (US); Olutayo IBIKUNLE, Upper Montclair, NJ (US)

(73) Assignee: JPMorgan Chase Bank, N.A., New York, NY (US)

(21) Appl. No.: 17/447,845

(22) Filed: Sep. 16, 2021

Related U.S. Application Data
(60) Provisional application No. 63/089,176, filed on Oct. 8, 2020.

(51) Int. Cl. G06Q 10/06

(52) U.S. Cl. CPC G06Q 10/067; G06Q 10/0637

(57) ABSTRACT

A method and a system for providing a distributed data architecture are provided. The method includes: defining a scope of a business problem space; identifying solution domains that relate to the defined scope; defining a bounded context that relates to a domain-specific solution for each of the identified solution domains; defining boundaries between the bounded contexts; and using the bounded contexts to define domain models, key entities, relationships, aggregates, applications, application programming interfaces, and events.

### CROSS-REFERENCE TO RELATED APPLICATIONS

This application claims the benefit of U.S. Provisional Patent Application Ser. No. 63/089,176, filed Oct. 8, 2020, which is hereby incorporated by reference in its entirety.

### BACKGROUND

### 1. Field of the Disclosure

This technology generally relates to methods and systems for providing a data architecture, and more particularly, to methods and systems for providing a data architecture and implementation strategy designed to support the development of data and analytics assets with speed and scale.

### 2. Background Information

The need to provide a rich customer experience through business and technology driven innovation has led to a recognition that conventional data and analytics architectures will require a transformation in order to achieve more customer-centric, autonomous, and product-aligned applications deployed as microservices that enable speed, agility, and resiliency at scale.

Conventional data and analytics architectures have evolved from a monolithic data warehouse, to a monolithic data lake, and more recently to a monolithic data hub for in-place consumption. This centralized and monolithic architecture may be managed and operated by a centralized team, which tries to satisfy all of the data and analytics demand for an organization.

Such conventional architectures facilitate a delivery of data in a managed and controlled manner, while providing economies of scale on centralized data infrastructure. However, in recent years, there has been an exponential growth of data generated within the organization and managed within the central data lake. There has also been a corresponding growth in the diversity of use cases consuming data from the lake and a need for fast-time-to-value from such data, through data-driven capabilities such as analytics and artificial intelligence/machine learning (AI/ML). This rate of business-driven change has begun to introduce significant bottlenecks for data production and consumption within the organization. Centralizing data engineering does not account for the level of domain expertise anticipated to respond to this data-driven change in a nimble manner. Further, there may be legacy domain data silos that have locked-up potential value as a shared asset and therefore inhibit data-driven innovation. Finally, there is a need to maximize the capabilities and benefits offered by the hybrid cloud for big data.

Accordingly, there is a need for methods and systems for providing a data architecture and implementation strategy designed to support the development of data and analytics assets with speed and scale.

### SUMMARY

The present disclosure, through one or more of its various aspects, embodiments, and/or specific features or sub-components, provides, inter alia, various systems, servers, devices, methods, media, programs, and platforms for methods and systems for providing a data architecture and implementation strategy designed to support the development of data and analytics assets with speed and scale.

According to an exemplary embodiment, a method for providing a distributed data architecture is provided. The method is implemented by at least one processor. The method includes: defining, by the at least one processor, a scope of a business problem space; identifying, by the at least one processor, at least two solution domains that relate to the defined scope; defining, by the at least one processor, at least one respective bounded context that relates to a domain-specific solution for each of the identified at least two solution domains; defining, by the at least one processor, a boundary between a first one of the defined at least one respective bounded context and a second one of the at least one respective bounded context; and using, by the at least one processor, each of the at least one respective bounded context to define each of a corresponding domain model, a corresponding key entity, a corresponding relationship, and a corresponding aggregate.

The method may further include using, for at least a first one of the at least one respective bounded context, each of the corresponding domain model, the corresponding key entity, the corresponding relationship, and the corresponding aggregate to define each of a corresponding application, a corresponding application programming interface (API), and a corresponding event.

The defining of the scope of the business problem space may include defining at least one scenario that relates to a data asset.

The defining of the scope of the business problem space may include defining at least one scenario that relates to a data analytics item.

The method may further include: generating, based on at least one from among the corresponding domain model, the corresponding key entity, the corresponding relationship, the corresponding aggregate, the corresponding application, the corresponding API, and the corresponding event, a plurality of data assets; publishing the plurality of data assets to a catalog; and associating, within the catalog, each respective one of the plurality of data assets to at least one from among of a corresponding addressability characteristic, a corresponding interoperability characteristic, a corresponding accessibility characteristic, and a corresponding service level objective (SLO).

The method may further include using, for each respective one of the plurality of data assets, an associated total cost of ownership (TCO) characteristic and an associated profit and loss (P&L) characteristic to determine a relative prioritization of the plurality of data assets.

The method may further include assigning, to each respective one of the plurality of data assets based on one from among a source thereof and a consumption thereof, a corresponding domain ownership. An ownership of an infrastructure layer of the distributed data architecture may be assigned to a single central ownership entity.

The method may further include defining a plurality of standards for the distributed data architecture. The plurality of standards may include at least a first standard that is applicable to each producer of at least one respective one of the plurality of assets and at least a second standard that is applicable to each consumer of at least one respective one of the plurality of assets.

According to another exemplary embodiment, a computing apparatus for providing a distributed data architecture is provided. The computing apparatus includes a processor; a memory; and a communication interface coupled to each of the processor and the memory. The processor is configured to: define a scope of a business problem space; identify at least two solution domains that relate to the defined scope; define at least one respective bounded context that relates to a domain-specific solution for each of the identified at least two solution domains; define a boundary between a first one of the defined at least one respective bounded context and a second one of the at least one respective bounded context; and use each of the at least one respective bounded context to define each of a corresponding domain model, a corresponding key entity, a corresponding relationship, and a corresponding aggregate.

The processor may be further configured to use, for at least a first one of the at least one respective bounded context, each of the corresponding domain model, the corresponding key entity, the corresponding relationship, and the corresponding aggregate to define each of a corresponding application, a corresponding application programming interface (API), and a corresponding event.

The processor may be further configured to define the scope of the business problem space by defining at least one scenario that relates to a data asset.

The processor may be further configured to define the scope of the business problem space by defining at least one scenario that relates to a data analytics item.

The processor may be further configured to: generate, based on at least one from among the corresponding domain model, the corresponding key entity, the corresponding relationship, the corresponding aggregate, the corresponding application, the corresponding API, and the corresponding event, a plurality of data assets; publish the plurality of data assets to a catalog; and associate, within the catalog, each respective one of the plurality of data assets to at least one from among of a corresponding addressability characteristic, a corresponding interoperability characteristic, a corresponding accessibility characteristic, and a corresponding service level objective (SLO).

The processor may be further configured to use, for each respective one of the plurality of data assets, an associated total cost of ownership (TCO) characteristic and an associated profit and loss (P&L) characteristic to determine a relative prioritization of the plurality of data assets.

The processor may be further configured to assign, to each respective one of the plurality of data assets based on one from among a source thereof and a consumption thereof, a corresponding domain ownership. An ownership of an infrastructure layer of the distributed data architecture may be assigned to a single central ownership entity.

The processor may be further configured to define a plurality of standards for the distributed data architecture. The plurality of standards may include at least a first standard that is applicable to each producer of at least one respective one of the plurality of assets and at least a second standard that is applicable to each consumer of at least one respective one of the plurality of assets.

According to yet another exemplary embodiment, a non-transitory computer readable storage medium storing instructions for providing a distributed data architecture is provided. The storage medium includes executable code which, when executed by a processor, causes the processor to: define a scope of a business problem space; identify at least two solution domains that relate to the defined scope; define at least one respective bounded context that relates to a domain-specific solution for each of the identified at least two solution domains; define a boundary between a first one of the defined at least one respective bounded context and a second one of the at least one respective bounded context; and use each of the at least one respective bounded context to define each of a corresponding domain model, a corresponding key entity, a corresponding relationship, and a corresponding aggregate.

When executed by the processor, the executable code may further cause the processor to use, for at least a first one of the at least one respective bounded context, each of the corresponding domain model, the corresponding key entity, the corresponding relationship, and the corresponding aggregate to define each of a corresponding application, a corresponding application programming interface (API), and a corresponding event.

When executed by the processor, the executable code may further cause the processor to define at least one scenario that relates to a data asset.

When executed by the processor, the executable code may further cause the processor to define at least one scenario that relates to a data analytics item.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for providing a data architecture and implementation strategy designed to support the development of data and analytics assets with speed and scale.

FIG. 4 is a flowchart of an exemplary process for implementing a method for providing a data architecture and implementation strategy designed to support the development of data and analytics assets with speed and scale.

FIG. 5 is a data mesh diagram that illustrates data flows generated by a method for providing a data architecture and implementation strategy designed to support the development of data and analytics assets with speed and scale, according to an exemplary embodiment.

FIG. 6 is a data flow diagram that illustrates a domain-driven design concept for use in conjunction with a method for providing a data architecture and implementation strategy designed to support the development of data and analytics assets with speed and scale, according to an exemplary embodiment.

FIG. 7 is a data flow diagram that illustrates the domain-driven design concept of FIG. 6 with included scenarios for data and analytics, according to an exemplary embodiment.

FIG. 8 is a block diagram of a distributed data lake by which data assets are aligned to source domains or consumer domains, according to an exemplary embodiment.

FIG. 9 is a data flow diagram that illustrates an alignment of data flows with axis of change, according to an exemplary embodiment.

FIG. 10 is a data flow diagram that illustrates an implementation of a method for providing a data architecture and implementation strategy for a credit card fraud and disputes use case, according to an exemplary embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

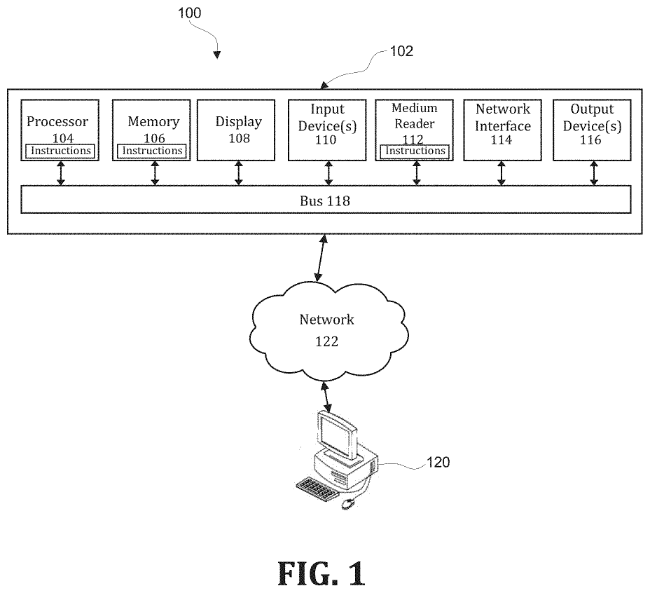

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g. software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionality as described herein, and a processor described herein may be used to support a virtual processing environment.

As described herein, various embodiments provide optimized methods and systems for providing a data architecture and implementation strategy designed to support the development of data and analytics assets with speed and scale.

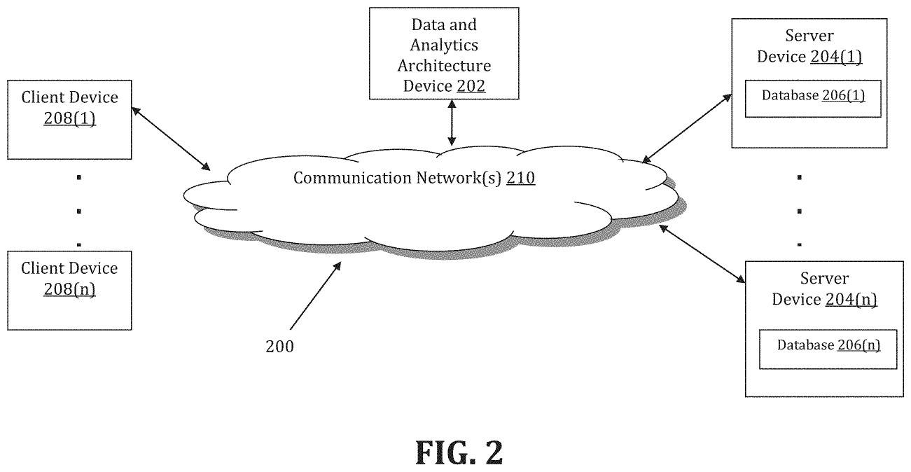

Referring to FIG. 2, a schematic of an exemplary network environment 200 for implementing a method for providing a data architecture and implementation strategy designed to support the development of data and analytics assets with speed and scale is illustrated. In an exemplary embodiment, the method is executable on any networked computer platform, such as, for example, a personal computer (PC).

The method for providing a data architecture and implementation strategy designed to support the development of data and analytics assets with speed and scale may be implemented by a Data and Analytics Architecture (DAA) device 202. The DAA device 202 may be the same or similar to the computer system 102 as described with respect to FIG. 1. The DAA device 202 may store one or more applications that can include executable instructions that, when executed by the DAA device 202, cause the DAA device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the DAA device 202 itself, may be located in virtual server(s) running in a cloud-based computing environment rather than being tied to one or more specific physical network computing devices. Also, the application(s) may be running in one or more virtual machines (VMs) executing on the DAA device 202. Additionally, in one or more embodiments of this technology, virtual machine(s) running on the DAA device 202 may be managed or supervised by a hypervisor.

In the network environment 200 of FIG. 2, the DAA device 202 is coupled to a plurality of server devices 204(1)-204(n) that hosts a plurality of databases 206(1)-206(n), and also to a plurality of client devices 208(1)-208(n) via communication network(s) 210. A communication interface of the DAA device 202, such as the network interface 114 of the computer system 102 of FIG. 1, operatively couples and communicates between the DAA device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the DAA device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and DAA devices that efficiently implement a method for providing a data architecture and implementation strategy designed to support the development of data and analytics assets with speed and scale.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The DAA device 202 may be a standalone device or integrated with one or more other devices or apparatuses, such as one or more of the server devices 204(1)-204(n), for example. In one particular example, the DAA device 202 may include or be hosted by one of the server devices 204(1)-204(n), and other arrangements are also possible. Moreover, one or more of the devices of the DAA device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the DAA device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) host the databases 206(1)-206(n) that are configured to store data management and governance standards and information relating to data and analytics applications.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the DAA device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the DAA device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the DAA device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the DAAP device 202, the server devices 204(1)-204(n), or the client devices 208(1)-208(n), for example, may be configured to operate as virtual instances on the same physical machine. In other words, one or more of the DAA device 202, the server devices 204(1)-204(n), or the client devices 208(1)-208(n) may operate on the same physical device rather than as separate devices communicating through communication network(s) 210. Additionally, there may be more or fewer DAA devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

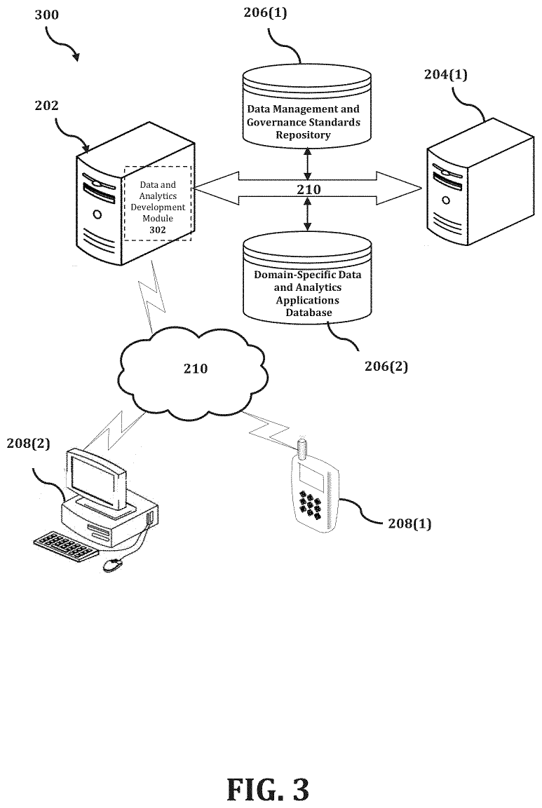

The DAA device 202 is described and shown in FIG. 3 as including a data and analytics development module 302, although it may include other rules, policies, modules, databases, or applications, for example. As will be described below, the data and analytics development module 302 is configured to implement a method for providing a data architecture and implementation strategy designed to support the development of data and analytics assets with speed and scale in an automated, efficient, scalable, and reliable manner.

An exemplary process 300 for implementing a method for providing a data architecture and implementation strategy designed to support the development of data and analytics assets with speed and scale by utilizing the network environment of FIG. 2 is shown as being executed in FIG. 3. Specifically, a first client device 208(1) and a second client device 208(2) are illustrated as being in communication with DAA device 202. In this regard, the first client device 208(1) and the second client device 208(2) may be “clients” of the DAA device 202 and are described herein as such. Nevertheless, it is to be known and understood that the first client device 208(1) and/or the second client device 208(2) need not necessarily be “clients” of the DAA device 202, or any entity described in association therewith herein. Any additional or alternative relationship may exist between either or both of the first client device 208(1) and the second client device 208(2) and the DAA device 202, or no relationship may exist.

Further, DAA device 202 is illustrated as being able to access a data management and governance standards repository 206(1) and a domain-specific data and analytics applications database 206(2). The data and analytics development module 302 may be configured to access these databases for implementing a method for providing a data architecture and implementation strategy designed to support the development of data and analytics assets with speed and scale.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the DAA device 202 via broadband or cellular communication. Of course, these embodiments are merely exemplary and are not limiting or exhaustive.

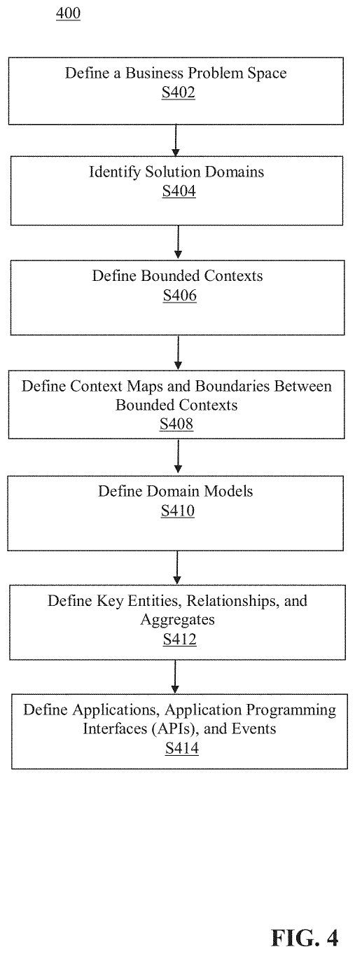

Upon being started, the data and analytics development module 302 executes a process for providing a data architecture and implementation strategy designed to support the development of data and analytics assets with speed and scale. An exemplary process for providing a data architecture and implementation strategy designed to support the development of data and analytics assets with speed and scale is generally indicated at flowchart 400 in FIG. 4.

In the process 400 of FIG. 4, at step S402, the data and analytics development module 302 defines a business problem space by using business scenarios to identify customer objectives and associated business processes. In an exemplary embodiment, the scenarios may include scenarios that relate to specific data assets and/or specific analytics items.

At step S404, the data and analytics development module 302 identifies solution domains that are relevant to the defined business space. Each identified solution domain can then be analyzed to determine domain-specific aspects of the data architecture.

At step S406, the data and analytics development module 302 defines a bounded context as an autonomous solution for each solution domain identified in step S404. Then, at step S408, context maps are defined by defining boundaries between the bounded contexts.

At step S410, the data and analytics development module 302 uses the bounded contexts to define domain models, which in turn are used in step S412 for defining key entities, relationships, and aggregates for each solution domain. Finally, at step S414, the data and analytics development module 302 defines applications, application programming interfaces (APIs), and events for each solution domain.

According to an exemplary embodiment, a modern data architecture and implementation strategy that supports the development of organizational data and analytics assets with speed and scale is presented. The architecture supports a domain aligned and product-oriented model, by which data assets will be produced closest to where the domain expertise and ownership lies, and which treats data as a product. The architecture is designed to create customer-focused, domain data assets that are rich in value for consumption. The product owners are responsible for and incentivized to expose their data assets in a well-defined and standardized manner for broader consumption across various domains. The architecture treats Domain Data Assets as first class citizens, while the data lake and pipeline, although key enabling technology platforms, become secondary concerns.

The architecture relies on two foundational capabilities to make it scalable: 1) the automation of common data management and governance capabilities to make data assets accessible to the various domains in a consistent and secure manner, and 2) a centrally owned and operated data infrastructure layer to minimize technology overhead and leverage the economies of scale. Common distributed storage and data platform architecture integrated with common data management standards and governance controls also facilitates an ability of big data use cases to access the capabilities and benefits of a hybrid cloud data platform.

Application assets that support operational workflows such as customer service, payments, and point of sale interactions are aligned to the “operational” capabilities of products, and as such are referred to herein as “operational applications.” Alternatively, application assets that consume business data to provide planning, forecasting, and automated decision making, are aligned to the “data and analytics” capabilities of products. These data-oriented application assets are composed of modules that can be organized into five broad groups: raw data sets, derived data sets, algorithms (heuristics, data science), decision support (reports, analytics), and automated decision making (ML features and models, AI algorithms). These product types are listed in terms of increasing complexity, and are referred to herein as “data application assets” or “data assets.”

In an exemplary embodiment, a data architecture is based on an inversion of a centralized and monolithic data architecture in order to realize a more distributed data architecture of domain-aligned data assets and pipelines. The data architecture intentionally decentralizes the data assets into the various domains, putting the domain data experts in charge. Instead of flowing the data from domains into a monolithic and centrally owned data lake, the various domains need to host and serve their domain data assets in a fast and easily consumable way on a distributed data lake. The architecture treats domain ownership and governance of data that the domain produces and consumes as a primary concern, while relegating data infrastructure (i.e., data platform and services) as a secondary concern. The physical storage location where the datasets actually reside and how they flow leverage centralized infrastructure, such as, for example, object stores on the hybrid cloud, but data content and ownership remains with the domain generating or consuming the data. Domain data owners must treat their data as “assets” they serve to the organization.

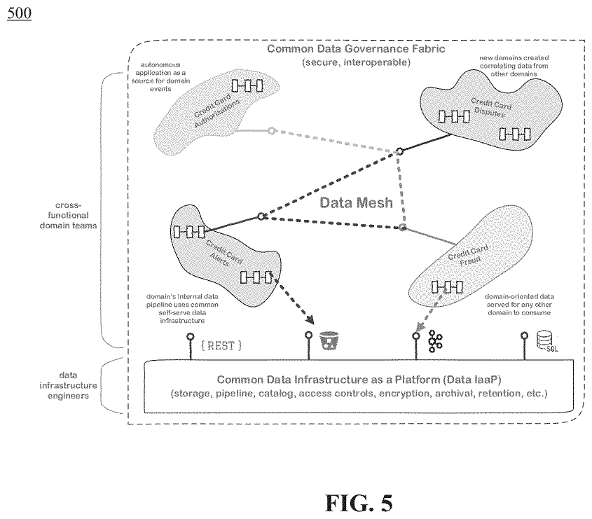

FIG. 5 is a data mesh diagram 500 that illustrates data flows generated by a method for providing a data architecture and implementation strategy designed to support the development of data and analytics assets with speed and scale, according to an exemplary embodiment.

Referring to FIG. 5, the Data Mesh concept is illustrated in the context of a credit card line of business. Instead of data flowing from “Credit Card Authorizations” into a centralized data lake for a centralized team to process through the disconnected stages of ingest, transform, and provision, a “Credit Card Authorizations Domain” may own and serve its data sets for access by any team for any purpose downstream. The physical location where the data sets actually reside and how they flow is a technical implementation of the “Credit Card Authorizations Domain.” The underlying physical data platform (i.e., storage, data pipeline, data management, etc.) is a centralized infrastructure that is universally accessible and standardized for the organization. However, Credit Card Authorization content and ownership of data sets remains with the domain generating them. Similarly, as also illustrated in FIG. 5, the “Credit Card Disputes” domain creates data sets in a format that is suitable for Fraud Analysts researching Credit Card Disputes, such as a dimensional data model where data is represented as a time-series of disputes (facts), at the customer account level (dimensions), while consuming the Credit Card Authorizations data sets in order to correlate to historical customer transactions. If there are other “solution domains” such as the “Credit Card Fraud Domain” which find the “Credit Card Disputes Domain” data sets useful, they can choose to pull and consume those data sets.

This represents a paradigm shift from a “push model” to a “pull model” as data is consumed across all domains. More specifically, in the conventional model, data moves through multiple disconnected stages before it can be consumed. A consumer requires a source team to push data, and a centralized data pipeline team to ingest and process the data in stages within a centralized, domain-agnostic Data Lake, before serving it for consumption. Each of these stages is a unit-of-change in the architecture, executed by separate teams, requiring separate hand-offs, that collectively result in longer processing times. By contrast, in the target Data Mesh-based model, a consumer directly pulls the desired data, served from an appropriate domain, and from a distributed, domain-oriented Data Lake, before consuming. This implies that data may be intentionally duplicated data in different “solution domains” as the data is transformed into a shape and format that is suitable for that particular domain's consumption needs. This also implies that the architectural unit of change in the domain-oriented data architecture is a “solution domain,” and not a “pipeline stage.”

In accordance with an exemplary embodiment, in addition to domain-oriented data architecture, the methodology also relies on other critical capabilities such as: 1) Robust Information Architecture standards and taxonomies; 2) Well-defined, centralized Product Catalog; 3) Automated Data Quality and Data Governance; 4) Self-service, cloud-native data infrastructure; and 5) Strong Data Strategy and Data Program Management.

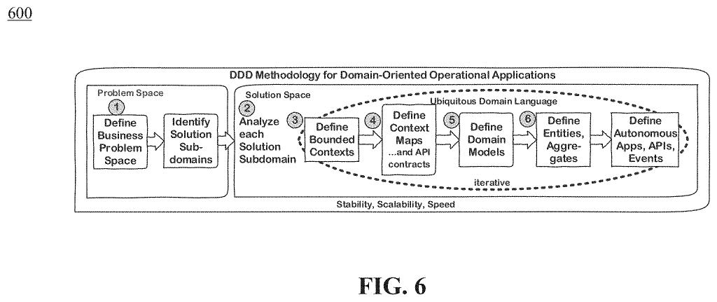

FIG. 6 is a data flow diagram 600 that illustrates a domain-driven design concept for use in conjunction with a method for providing a data architecture and implementation strategy designed to support the development of data and analytics assets with speed and scale, according to an exemplary embodiment.

Domain Data Assets: In order to decentralize the monolithic data architecture, the domain boundaries and data ownership need to be drawn clearly. Domain Driven Design (DDD) facilitates a design and engineering of autonomous operational applications to achieve the key objectives of stability, scalability and speed. As illustrated in FIG. 6, the first step is (1) defining the business problem space and use business scenarios to help identify the customer journeys and business processes involved and to scope out the solution space by honing in on the specific business domains that are relevant to the problem space. Next, analyze each domain (2) involved in the solution space, define its bounded context (3) as an autonomous solution for each domain, define boundaries between these domain bounded contexts (4), use the bounded contexts to define domain models (5), and key entities, relationships, and aggregates (6). Context maps (4) identify relationships between domain contexts.

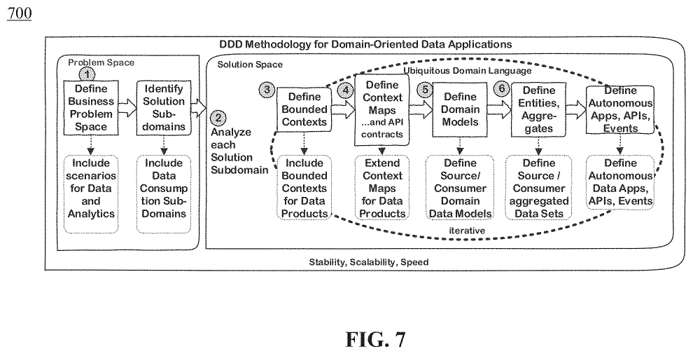

FIG. 7 is a data flow diagram 700 that illustrates the domain-driven design concept of FIG. 6 with included scenarios for data and analytics, according to an exemplary embodiment.

The next steps are to decentralize the monolithic data platform, and introduce the notion of domains, bounded contexts, context maps, and domain models to data assets. Referring to FIG. 7, a process for defining autonomous applications is illustrated. To make this happen, product owners need to consider their data and analytics scenarios and related use cases as an integral part of their product definition and roadmap. Some data and analytics use cases naturally align with a source domain—i.e. the domain where the operational data originates, such as, for example, Card Authorizations in FIG. 5, while some use cases align closely with the consumption of data from other domains for operational purposes—i.e. domains that rely on operational data from other domains for their existence, such as, for example, Card Alerts based on Fraud, Disputes, and Authorizations in FIG. 5. For source domain aligned use cases, a history of raw source data may be persisted outside of its operational stores. This might be for data consumption within the source domain, or to share the domain's historical business facts with other domains. Conversely, consumption aligned domains rely on one or more external domains to provide data for operational and analytics purposes. In this case, it becomes the consumer domain's responsibility to source, process, and serve that data for consumption within its own domain, and also to become the authoritative source for its data asset to other domains. An example of this consumer domain might be aligned with the finance domain, for which there is a need to aggregate P&L across multiple products.

There may be a need to create a new solution domain as none of the existing (source or consumer) solution domains align well with the data and analytics business needs. FIG. 7 illustrates how the DDD methodology can be extended to data solutions. It starts with a product definition that includes operational and data and analytics business scenarios within its product vision and roadmap. The following sections describe the key characteristics of the Source and Consumer Domain Data Sets that are the foundational components of their respective data application assets.

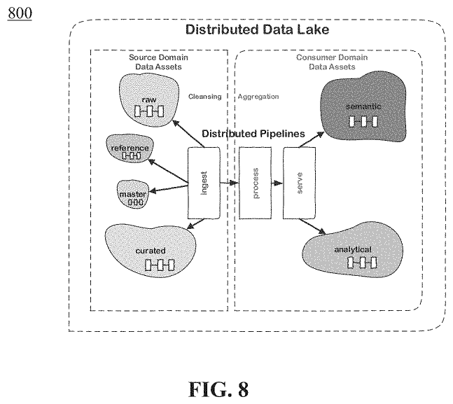

FIG. 8 is a block diagram 800 of a distributed data lake by which data assets are aligned to source domains or consumer domains, according to an exemplary embodiment.

Source Domain Data Sets: Referring to FIG. 8, source domain data sets represent the facts and realities of the business, and obtain their data from authoritative sources such as Systems of Record (SOR). They are not fitted or modeled for a particular consumer, and can be consumed as-is. For example, Credit Card Authorizations data is used to detect new fraud trends aligns with the Transactions Authorization subdomain, and the Credit Card Authorizations business platform. Source domain data sets persist data history from customer interactions and business operations in an immutable and temporal form. Data engineers in these domains are typically involved in activities to cleanse, de-duplicate, and curate source data. The data persisted must comply with an organizational records retention policy. Source domain data sets must be separated from the operational source systems' data sets, as the nature of the source domain data sets is very different from the internal data that the operational systems use to perform their job. Source domain data sets have a much larger volume, represent immutable timed facts, and change less frequently than their originating systems. For this reason their actual underlying storage must be suitable for big data, and separate from the existing operational databases.

Source data is captured in a couple of ways:

1) Immutable Domain Events: These domain events must ensure fidelity to the SORs, and must be accessible as time-stamped domain events for consumption. They must not be modeled for a particular consumption use case, however, only domain events that are of interest for data and analytics consumption and defined by the relevant bounded contexts are of interest. Often, there are multiple systems that can serve parts of a complete source domain data asset, some originating from legacy monolithic applications, and some from modern autonomous applications. As a result, there might be many source domain data sets that need to be pieced together into a cohesive source domain data asset.

2) Immutable Domain Snapshots: This includes any type of transactional, master, reference, and external data aligned to the domain. Historical snapshots may be aggregated over a time interval that closely reflects the interval of change for their domain. Snapshots can be uni-temporal (i.e., a view of data at an isolated point in time, such as, for example, a specified customer's account snapshot on Dec. 31, 2019), or bi-temporal (i.e., a view of data between two isolated points in time, such as, for example, a specified customer's daily account balances between Dec. 1, 2019 and Dec. 31, 2019).

Source domain data sets are the most foundational data sets and change less often, as the facts of business do not change that frequently. These data sets are expected to be permanently captured and made available, so that as the organization evolves its data-driven services and intelligence services, they can always go back to the business facts and create new aggregations or projections.

Consumer Domain Data Sets: Referring to FIG. 8, consumer domain data sets aim to satisfy a closely related group of data consumption use cases. For example, account-level, credit card fraud risk scores present an aggregated and enriched view that can be used to calculate wholesale risk, or customer level credit line increase decisions. In an exemplary embodiment, the “Credit Card-Fraud-Risk Scores” data set aligns with the Fraud Reporting & Analytics subdomain, and Credit Card Fraud and Risk business platform. The Fraud & Risk domain team focuses on providing an always-curated and up-to-date view of each customer's Credit Card Fraud and Risk Profile in order to protect the customer. Similarly, Marketing and Sales are examples of other consumer-oriented domains. These domains are typically involved in activities to aggregate and enrich data from multiple source or consumer domains.

Consumer domain data sets may be more complicated to produce and keep up-to-date than source domain data sets. First, they aim to satisfy a broad spectrum of data consumption use cases—from a variety of analytics use cases to highly controlled regulatory reporting. Second, multiple data inputs, go through a series of structural changes as they transform into new aggregate views and semantic structures that fit a particular consumption model. Consumer domain data sets fall into two distinct categories: Analytical and Semantic—each having different modeling, maturity, durability, and “share” ability characteristics.

Analytical Data Sets: These data sets are developed for specialized consumption, targeting a closely related group of use cases and business purposes, either within or across domains. For example, Consumer Banking-Deposits-Customer-Fraud is a highly specialized consumer domain data set, developed to support Deposit, Customer, Fraud, and Analytics performed by Fraud domain analysts. It does not have broad “share” ability, and is typically implemented as a domain data mart. Such data assets can take any shape or form, such as, for example, wide, flattened, hierarchical, key-value pairs, pre-joined, pre-filtered, pre-sorted, networks, or graphs—whatever is needed to enable business agility and response with rapid exploration and analytics. These data sets have a maturity durability, and “share” ability is dictated by the targeted use cases.

Semantic Data Sets: These data sets utilize core domain entities and their relationships to create simple domain-specific business views. The main goal is to hide the complexity of the underlying data, and deliver a consistent view of the business facts, metrics, dimensions, and hierarchies that can be used for reporting or data analysis within a domain. Historically, data warehouse engineers have sought to enable a degree of trustworthiness and reusability of such semantic data sets that are a) presented from a business perspective by domain subject areas, b) highly cleansed and curated, and c) aligned to the key domain master data entities and relationships. The semantic data model presents the business with a ready to use interface to their data for ad-hoc analytics, regulatory reporting, and curated business metrics.

Common Data Management and Governance Standards: Common data management standards and governance forms a foundational pillar and becomes more critical as ownership and management of data assets are federated into the various domains of the distributed data mesh. These common standards are required to ensure the distributed domain data sets are interoperable, discoverable, expose their lineage, provenance, quality, and are classified consistently for secure access. They ensure that the distributed polyglot domain data sets can be effectively correlated and integrated across domains based on standardized information taxonomies, techniques to identify polysemes across different domains, and standardized data harmonization rules such as field type formatting, data set address conventions, metadata fields, event formats, etc. Compliance Policies such as General Data Protection Regulation (GDPR), California Consumer Privacy Act (CCPA), or Privacy Policies dictate how data can be integrated, stored, measured, and accessed for use. Master and reference data tags applied at the data set level provide a globally consistent view of these data assets.

Governance of these standards is essential for transparency, integrity, compliance, and helps to avoid a data maze. Automated monitoring and governance of these standards and policies is essential for implementing the data mesh architecture at scale.

Equally essential is a common data catalog that is business friendly, self-service, and governed, and allows users to easily search for and provision data in a governed yet automated fashion. This encourages collaboration and instills a product mindset for both data producers and consumers.

Data Assets Managed as Products: A product culture to developing and managing our data assets is important. Products are designed to create customer value, and this product mindset applied to data assets provides value in the form of raw, transformed, enriched data, or published information. Data assets managed as products offer the following distinct benefits to the modern data architecture:

1) Vision: Because each data asset is ultimately assigned to a product managed by the business, product owners make long-term decisions to benefit the product, including stable teams, long-term funding, with incentives to ensure that the product has a long useful life span.

2) Domain Expertise: Stable teams imply better domain knowledge and retention, and leverage the ubiquitous domain language to design and operate their data assets.

3) Nimbleness: The data asset (product) backlog provides a continuous stream of small new features constantly being added and reprioritized based on customer demand.

4) Accountability: Teams are incented to build efficiencies, modernize their assets, reduce infrastructure footprint, and manage their overall costs better, driven by metrics and key performance indicators (KPIs).

5) Empowerment: Teams have autonomy, and control their own destiny to build and deploy their assets independent of other products, while being focused on exceeding their Service Level Objectives (SLO.

The big rules for “functional” data assets managed as products include the following: 1) Publish to the common product catalog for discoverability and broad consumption. 2) Define all underlying data they create in the common data catalog for understanding. 3) Access occurs only via a published APIs or approved interactive tools. 4) Produced and consumed based on a standard producer-consumer contract. 5) Provide an up-to-date view of its total cost of ownership (TCO) that ties into the overarching product profit and loss (P&L).

There are technology platforms that support data assets such as (i) Platform and Database, (ii) Analytics and Reporting, (iii) Data Pipeline, (iv) Data Management, and (v) AI/ML, which are managed as products by centralized teams providing standard data infrastructure as a platform for the organization.

Data APIs and Interactive Objects: How data consumers consume domain data assets is an important aspect of product thinking. There are two broad ways to consume data: APIs and Interactive Objects.

Data APIs have raw or enriched data sets as their product, with a data engineer, data scientist, or data analyst often being the consumer. Data APIs play a key role in the Data Mesh architecture and domain data owners must ensure that the API is intuitive, well documented, discoverable, interoperable, and secure. APIs for data assets follow the same domain driven design and naming standards and guidelines as defined for APIs supporting operational applications in accordance with organizational rules. This includes the steps to derive APIs based on DDD techniques, using context maps, bounded contexts, and aggregate interfaces exposing the underlying domain model. Data sets should only be accessed via their published APIs.

Interactive Objects such as Dashboard and Visualization products assume access to data by a data or business analyst with statistical and analytical skillset. These products are flush with self-service capabilities to help quickly and interactively prototype and publish pertinent information in a form of software modules created and maintained within the Dashboard or Visualization product, in a way that is easy to understand and to influence decision-making.

Data Producer and Consumer Contract: The Data Producer creates data (i.e., source data, transformed data, or enriched data), and is responsible for publishing data assets to a common Product Catalog. The data producer is also responsible for exposing the data assets via standardized APIs, and registering the underlying data sets in the common Data Catalog. These data sets need to factor in basic registration, cleansing, and formatting to facilitate easy consumption, and to avoid duplicating these tasks at the consumer end. Each domain data asset must establish its Service Level Objectives, which is a key data producer responsibility and the data owner's accountability.

The Data Consumers must use data solely for purposes of supporting their business scenarios, and deriving business value from the data. They must be able to access data based on their entitlements, and commensurate to their role. They must ensure they do not redistribute data that they consume as it violates data management standards and product ownership protocols. Data sets are pulled by the consumer, rather than pushed to the consumer.

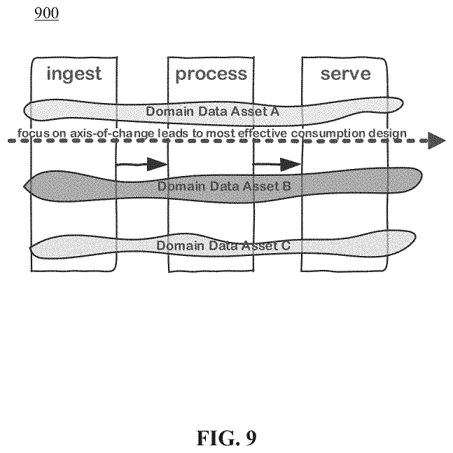

FIG. 9 is a data flow diagram 900 that illustrates an alignment of data flows with axis of change, according to an exemplary embodiment.

The data consumer is focused on efficient data consumption. Referring to FIG. 9, producers must focus on design and development efficiencies along an axis of change, and consumers should never get mired in any friction introduced by the discrete data pipeline stages (i.e., ingest, transform, and serve), which are orthogonal to this axis of change. Consumers build trust in the data assets they consume over time based on their experiences, and are responsible for providing feedback to the producer on data quality, unmet SLOs, and overall experience.

Data Infrastructure-as-a-Platform (Data IaaP): Common self-service data platforms and integrated data management services form a foundational layer of the distributed data mesh architecture. Cross cutting capabilities such as data storage, security, processing, consumption, management, and governance apply equally to all domains, and must be treated as business invariant, utility services. This is referred to herein as Data Infrastructure as a Platform or Data IaaP. This architectural layer is owned and operated centrally to support standardization of these capabilities, and to provide economies of scale across the organization. This will also allow product owners and domain data teams to focus on solving real business problems with their data and information supply chains.

In an exemplary embodiment, all domains must use the Data IaaP and the underlying standardized tech stack for data production and consumption, as a common utility that is accessible across the organization. However, in certain cases where domain data is produced and hosted externally, or a domain has a distinct consumption need, they would be able to integrate with the data mesh as long as they meet applicable data producer and data consumer contract requirements.

Key Characteristics of the Modern Data Architecture: Product owners strive to delight their customers and provide the best customer experience. For data assets to be treated as products, they must exemplify the following characteristics:

1) Domain Ownership: Domain data asset owners must manage their data assets as “products” they produce, and treat the data scientists and data engineers from various domains as their “customers” who consume these products. Distribution of the data ownership and data pipelines into the hands of the domains raise a concern around accessibility to distributed data assets. Domain data producers must expose their data and avoid hoarding it in silos. They must adhere to all applicable data governance standards.

Discoverable: Domains must publish their data assets to the common product catalog to enable discovery, identify their ownership, and how they can be used. Domain experts are responsible for key metadata on their data assets such as schema, ownership, provenance, lineage, SLOs, use cases, to aide discoverability and reuse.

Addressable: Domains must adhere to a standard convention for uniquely addressing their data assets. This is imperative to enable programmatic search, access, and governance of their data sets in a polyglot environment with various storage types and formats.

Trustworthy: Domains must define the data assets they produce and attest to its level of quality, integrity and accuracy for the business facts they represent. These attributes can be explicitly defined as data asset SLOs, measured against acceptable quality ranges, and published along with the data assets on the product catalog. Data assets must have associated provenance and lineage metadata to further inform consumers on their trustworthiness. Data quality validation and cleansing must be done at point of creation where data is in context, and by domain experts who know their data the best. This activity must not be pushed down to the consumers. Technical data quality assurance can be automated and standardized.

Self-Describing: Data assets should be easy to understand and consume in a self-service manner. They must conform to a standardized dictionary of domain-aligned business terms such as “customer profile”, “credit line increase”, or “revenue-to-offer”, which are clearly defined within the context of each domain's business glossary. The schema, business semantics, and syntax (i.e., “Raw”, “Conformed”, “Semantic”, or “Analytical”) of the data needs to be well described and documented, along with sample data profiles and exemplar use cases.

Interoperable: Domains must implement APIs for all data assets per well-defined API standards. This ensures accessibility and interoperability of data assets within and across domains. A common concern to anticipate is the ability to correlate semantics and stitch (i.e., harmonize, join, and filter) data assets from multiple domains while preserving their semantics and integrity. This need is more pronounced when creating semantic data objects, where data models embody interfaces and must abide by standard data modeling rules: granularity, semantics, subject areas, aggregate intervals, etc. Standardizing naming, addressing, content encoding, attribute types, valid values, mechanisms to identify polysemes, common metadata, and automating governance is key.

Secure: Data-centric security and access controls that is enforced at a row, column, and geographic region level, using organizational Identity and Access Management and Policy Based Access Control is imperative in a decentralized model. Access control policies must be authored and managed centrally for all platforms, enforced at point of access to each data set on any platform, and monitored by the organizational cybersecurity infrastructure.

Consumable: Domain data assets are only created with the intent of consuming them, and domains need to host and serve them in an easily consumable way. They are created in a shape and format that is suitable for each consumption need, and therefore data may be duplicated in a managed way as it is transformed each use case. The data assets are pulled by the consumer, rather than pushed to the consumer, and kept up-to-date based on standards such as Change Data Capture (CDC) or Append Logs. Data consumers must be able to easily navigate and access data solely for their consumption, and must not redistribute data that they consume, as it violates data management standards and product ownership protocols.

Strategic: Data assets such as shared semantic models that map core business entities and their relationships across multiple business domains are considered to have strategic value. They support critical data needs such as regulatory compliance reporting and other critical management information system (MIS) needs. These strategically important data assets must be produced (i.e., development, deployment), and managed (i.e., production quality) in a highly disciplined manner, with predictable SLOs and governed data platforms and supporting services.

Data Engineering Capabilities within the Domain:

Creating New Data Assets: Before creating new data assets, the common product catalog is searched for reusable data assets to support data and analytics needs. When none are found that fit the consumption need, the DDD methodology is used to create new data assets within a source or consumer solution domain. In some cases, there may be a need to create an entirely new consumer domain associated to a data and analytics consumption scenario.

Real-time data aggregation and enrichment for operational consumption, such as, for example, intelligent applications, may use operational APIs directly without the need for creating new data assets within the distributed data lake. In such cases, analytics and reporting domain event streams become part of the data mesh architecture, and data assets in their own right.

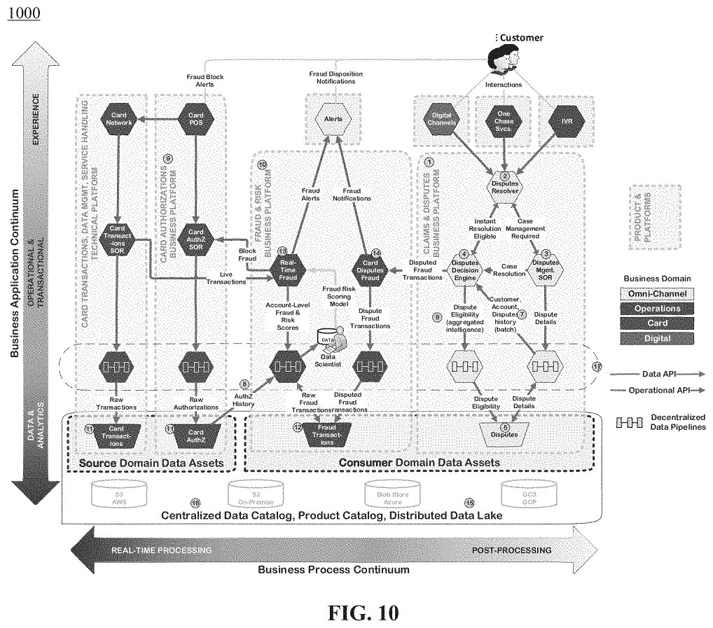

FIG. 10 is a data flow diagram 1000 that illustrates an implementation of a method for providing a data architecture and implementation strategy for a credit card fraud and disputes use case, according to an exemplary embodiment.

Referring to FIG. 10, functional architecture diagram 1000 illustrates the key concepts of a modern data architecture, including product and domain alignment of applications and data, using a Credit Card Fraud and Disputes use case, according to an exemplary embodiment. The functional architecture diagram 1000 shows how a product such as Claims & Disputes Business Platform 1, aligns with operational applications that run the business such as such as Disputes Resolver 2 and Disputes Management 3. The diagram 1000 also shows how data intensive analytics applications such as Disputes Decision Engine 4 leverage the Disputes Data Asset 5 in order to disposition disputes as “Recurring”, “Duplicate”, “Incorrect Amount”, “Incorrect Merchandise”, “Unrecognized Transaction”, etc. 6, based on historical customer, account, and merchant disputes 7. The architecture 1000 illustrates how data sets such as Account-Level Card Authorizations History 8 are shared across business domains (i.e., Card & Operations), as well as business platform products (i.e., Card Authorizations 9 and the Fraud & Risk Business Platform 10). Card Transactions and Card Authorizations are persisted in the distributed data lake as “source” domain data sets 11 as they persist Card Transactions and Card Authorizations SOR data respectively. Fraud Transactions and Dispute Decisions are persisted in the distributed date lake as “consumer” domain data sets 12, 5 as they serve-out data aggregated and enriched by business rules, machine learning, or other statistical/analytical model execution 13, 14. These analytical or machine learning models are developed and maintained by data scientists who are provided access to data they need via data pipeline interfaces, and provision data for “prospecting” into fit-for-purpose data containers. All source and consumer data sets are shared for cross-domain consumption via Data APIs. Finally, the architecture 1000 illustrates the concept of common data infrastructure as a platform that is data shared by all domains and products including the distributed data lake 15, central data and product catalog 16, and pipeline framework 17.

Accordingly, with this technology, an optimized process for implementing methods and systems for providing a data architecture and implementation strategy designed to support the development of data and analytics assets with speed and scale is provided.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for providing a distributed data architecture, the method being implemented by at least one processor, the method comprising:
defining, by the at least one processor, a scope of a business problem space;
identifying, by the at least one processor, at least two solution domains that relate to the defined scope;
defining, by the at least one processor, at least one respective bounded context that relates to a domain-specific solution for each of the identified at least two solution domains;
defining, by the at least one processor, a boundary between a first one of the defined at least one respective bounded context and a second one of the at least one respective bounded context; and
using, by the at least one processor, each of the at least one respective bounded context to define each of a corresponding domain model, a corresponding key entity, a corresponding relationship, and a corresponding aggregate.

2. The method of claim 1, further comprising using, for at least a first one of the at least one respective bounded context, each of the corresponding domain model, the corresponding key entity, the corresponding relationship, and the corresponding aggregate to define each of a corresponding application, a corresponding application programming interface (API), and a corresponding event.

3. The method of claim 2, wherein the defining of the scope of the business problem space includes defining at least one scenario that relates to a data asset.

4. The method of claim 2, wherein the defining of the scope of the business problem space includes defining at least one scenario that relates to a data analytics item.

5. The method of claim 1, further comprising:
generating, based on at least one from among the corresponding domain model, the corresponding key entity, the corresponding relationship, the corresponding aggregate, the corresponding application, the corresponding API, and the corresponding event, a plurality of data assets;
publishing the plurality of data assets to a catalog; and
associating, within the catalog, each respective one of the plurality of data assets to at least one from among of a corresponding addressability characteristic, a corresponding interoperability characteristic, a corresponding accessibility characteristic, and a corresponding service level objective (SLO).

6. The method of claim 5, further comprising using, for each respective one of the plurality of data assets, an associated total cost of ownership (TCO) characteristic and an associated profit and loss (P&L) characteristic to determine a relative prioritization of the plurality of data assets.

7. The method of claim 5, further comprising assigning, to each respective one of the plurality of data assets based on one from among a source thereof and a consumption thereof, a corresponding domain ownership,
wherein an ownership of an infrastructure layer of the distributed data architecture is assigned to a single central ownership entity.

8. The method of claim 5, further comprising defining a plurality of standards for the distributed data architecture, wherein the plurality of standards includes at least a first standard that is applicable to each producer of at least one respective one of the plurality of assets and at least a second standard that is applicable to each consumer of at least one respective one of the plurality of assets.

9. A computing apparatus for providing a distributed data architecture, the computing apparatus comprising:
a processor;
a memory; and
a communication interface coupled to each of the processor and the memory,
wherein the processor is configured to:
define a scope of a business problem space;
identify at least two solution domains that relate to the defined scope;
define at least one respective bounded context that relates to a domain-specific solution for each of the identified at least two solution domains;
define a boundary between a first one of the defined at least one respective bounded context and a second one of the at least one respective bounded context; and
use each of the at least one respective bounded context to define each of a corresponding domain model, a corresponding key entity, a corresponding relationship, and a corresponding aggregate.

10. The computing apparatus of claim 9, wherein the processor is further configured to use, for at least a first one of the at least one respective bounded context, each of the corresponding domain model, the corresponding key entity, the corresponding relationship, and the corresponding aggregate to define each of a corresponding application, a corresponding application programming interface (API), and a corresponding event.

11. The computing apparatus of claim 10, wherein the processor is further configured to define the scope of the business problem space by defining at least one scenario that relates to a data asset.

12. The computing apparatus of claim 10, wherein the processor is further configured to define the scope of the business problem space by defining at least one scenario that relates to a data analytics item.

13. The computing apparatus of claim 9, wherein the processor is further configured to:
generate, based on at least one from among the corresponding domain model, the corresponding key entity, the corresponding relationship, the corresponding aggregate, the corresponding application, the corresponding API, and the corresponding event, a plurality of data assets;
publish the plurality of data assets to a catalog; and
associate, within the catalog, each respective one of the plurality of data assets to at least one from among of a corresponding addressability characteristic, a corresponding interoperability characteristic, a corresponding accessibility characteristic, and a corresponding service level objective (SLO).

14. The computing apparatus of claim 13, wherein the processor is further configured to use, for each respective one of the plurality of data assets, an associated total cost of ownership (TCO) characteristic and an associated profit and loss (P&L) characteristic to determine a relative prioritization of the plurality of data assets.

15. The computing apparatus of claim 13, wherein the processor is further configured to assign, to each respective one of the plurality of data assets based on one from among a source thereof and a consumption thereof, a corresponding domain ownership,
wherein an ownership of an infrastructure layer of the distributed data architecture is assigned to a single central ownership entity.

16. The computing apparatus of claim 13, wherein the processor is further configured to define a plurality of standards for the distributed data architecture, wherein the plurality of standards includes at least a first standard that is applicable to each producer of at least one respective one of the plurality of assets and at least a second standard that is applicable to each consumer of at least one respective one of the plurality of assets.

17. A non-transitory computer readable storage medium storing instructions for providing a distributed data architecture, the storage medium comprising executable code which, when executed by a processor, causes the processor to:
define a scope of a business problem space;
identify at least two solution domains that relate to the defined scope;
define at least one respective bounded context that relates to a domain-specific solution for each of the identified at least two solution domains;
define a boundary between a first one of the defined at least one respective bounded context and a second one of the at least one respective bounded context; and
use each of the at least one respective bounded context to define each of a corresponding domain model, a corresponding key entity, a corresponding relationship, and a corresponding aggregate.

18. The storage medium of claim 17, wherein when executed by the processor, the executable code further causes the processor to use, for at least a first one of the at least one respective bounded context, each of the corresponding domain model, the corresponding key entity, the corresponding relationship, and the corresponding aggregate to define each of a corresponding application, a corresponding application programming interface (API), and a corresponding event.

19. The storage medium of claim 18, wherein when executed by the processor, the executable code further causes the processor to define at least one scenario that relates to a data asset.

20. The storage medium of claim 18, wherein when executed by the processor, the executable code further causes the processor to define at least one scenario that relates to a data analytics item.
